(19) United States
(12) Patent Application Publication
(10) Pub. No.: US 2006/0070950 A1
(43) Pub. Date: Apr. 6, 2006

(54) Composite filtration article

(75) Inventors: Jerald K. Rasmussen, Stillwater, MN (US); Andrew W. Rabins, St. Paul, MN (US); James I. Hembre, Plymouth, MN (US); Kannan Seshadri, Woodbury, MN (US); Kelly J. Gibbens, Vadnais Heights, MN (US); Masayuki Nakamura, Woodbury, MN (US); Robert T. Fitzsimons JR., Minneapolis, MN (US); Simon K. Shannon, Columbia Heights, MN (US); Stephen B. Roscoe, St. Paul, MN (US); Larry J. Carson, Maplewood, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/238,595

(22) Filed: Sep. 29, 2005

Related U.S. Application Data
(60) Provisional application No. 60/615,288, filed on Oct. 1, 2004.

(51) Int. Cl. B01D 15/08

(52) U.S. Cl. 210/635; 210/656; 210/198.2; 210/502.1; 210/660

(57) ABSTRACT

A composite filter medium comprising a filter element comprising at least one porous fibrous filtration layer, and at least one layer of a sorbent, stationary phase particulates selected from organic or inorganic particulates having an average diameter of less than 50 micrometers, soft particulates, and ground monolithic particulates. The particulates are capable of binding target molecule by, for example, adsorption, ion exchange, hydrophobic binding, and affinity binding. The particulates provide higher binding capacities than can be achieved using filter media incorporating conventional process scale chromatography resin particulates.

### FIELD OF THE INVENTION

This invention relates to an article and method for the separation and purification of a biomacromolecule from a solution that comprises one or a plurality of biomacromolecules, especially on a large scale. The purified biomacromolecules are useful therapeutic or diagnostic agents.

### BACKGROUND OF THE INVENTION

Biomacromolecules are constituents or products of living cells and include proteins, carbohydrates, lipids, and nucleic acids. Detection and quantification as well as isolation and purification of these materials have long been objectives of investigators. Detection and quantification are important diagnostically, for example, as indicators of various physiological conditions such as diseases. Isolation and purification of biomacromolecules are important for therapeutic purposes such as when administered to patients having a deficiency in the particular biomacromolecule, or when utilized as a biocompatible carrier of some medicament, and in biomedical research. Biomacromolecules such as enzymes, which are a special class of proteins capable of catalyzing chemical reactions, are also useful industrially; enzymes have been isolated, purified, and then utilized for the production of sweeteners, antibiotics, and a variety of organic compounds such as ethanol, acetic acid, lysine, aspartic acid, and biologically useful products such as antibodies and steroids.

In their native state in vivo, structures and corresponding biological activities of these biomacromolecules are maintained generally within fairly narrow ranges of pH and ionic strength. Consequently, any separation and purification operation must take such factors into account in order for the resultant, processed biomacromolecule to have potency.

Chromatography is a separation and purification operation that is often performed on biological product mixtures. It is a technique based on the interchange of a solute between a moving phase, which can be a gas or liquid, and a stationary phase. Separation of various solutes of the solution mixture is accomplished based on varying binding interactions of each solute with the stationary phase; stronger binding interactions generally result in longer retention times when subjected to the de-binding effects of a mobile phase compared to solutes which interact less strongly and, in this fashion, separation and purification can be effected.

Bioseparations have been conducted using modified filter cartridges. U.S. Pat. No. 5,155,144 discloses microporous sheets comprising modified polysaccharide particulates such as diethylaminoethyl cellulose, a typical ion exchange chromatography stationary phase, dispersed within a polymeric medium. It is suggested that these sheets can further be configured into a dead end filter cartridge.

Employing recirculation of effluent, a lead ion treated resin was evaluated as a generally shallow column between two stainless steel grids for the analytical separation of D-xylose (cf. A. M. Wilhelm and J. P. Riba, J. Chromatog., 1989, 484, 211-223). The resulting packed bed reactor system was evaluated to determine hydrodynamic conditions for particles for ultimate employment in columns for production liquid chromatography at relatively high system pressures and low flow rates.

A relatively new type of chromatographic medium, useful on the analytical scale, is the monolith. This type of medium is prepared by filling a chromatography column with appropriate monomers, solvents, and initiators, and conducting the polymer-forming reaction in place. A plug of porous polymer is formed that completely fills the column, and thus obviates the need for careful column packing. Monolithic media can have improved separation characteristics over particulate media. However, because of heat generation and heat transfer problems encountered during the polymerization process, scale up to large columns is problematic.

### SUMMARY OF THE INVENTION

Briefly, this invention provides a composite filter medium comprising a filter element comprising at least one porous fibrous filtration layer (e.g. a layer of a woven or nonwoven porous material), and at least one layer of a sorbent, stationary phase particulate capable of binding with a target molecule, the stationary phase particulates selected from the group of particles having an average diameter of less than 50 micrometers, soft polymeric particles, and crushed monolithic polymer particles.

Although the term “biomacromolecules” is used throughout this application as a preferred mode, it should be understood that the stationary phase particulates may also be capable of adsorbing or binding other target molecules as described herein below. The particulates are capable of binding biomacromolecules by, for example, adsorption, ion exchange, hydrophobic binding, or affinity binding. The particulates provide higher binding capacities and/or higher capture efficiencies and throughput than can be achieved using filter media incorporating conventional process scale chromatography resin particulates.

Large scale bioseparation processes (e.g., in biopharmaceutical manufacturing processes) are typically conducted in large diameter, packed chromatographic columns, with equilibration, loading, washing, elution, and regeneration/cleaning being performed sequentially. Because of kinetic limitations of protein adsorption (slow intraparticle diffusion of protein molecules within the chromatographic particles), these columns are typically only loaded to a fraction of their equilibrium capacity. The result is a relatively slow process with fairly low throughput.

As used herein “large scale bioseparation” is defined as a step in the downstream biopharmaceutical manufacturing process in which separation and/or purification of a biomacromolecule product produced in a bioreactor having a volume of 100 liters or more is accomplished. To prevent degradation of the biomolecule product, this bioseparation should be conducted in a period of 24 hours or less. Assuming a typical biomacromolecule concentration of about 1 gram/liter in the fluid medium produced in a bioreactor, this approximates the ability to purify at least 100 g of product in 24 hours.

For small scale, analytical purifications, the wall effects provided by small diameter columns (e.g., columns with a diameter less than about 5 cm) enables the use of chromatographic resins with a wide range of properties in terms of size, shape, rigidity, porosity, etc. In small chromatographic columns, the packed bed of chromatography resin is well supported by the column wall so that resins having a relatively wide range of properties can be utilized and can withstand differential pressures well in excess of 200 psi (1.38 MPa) without causing damage to the resin particles. These wall effects diminish as the diameter of the column increases, and become insignificant with diameters greater than 20 cm.

Therefore, with the large diameter columns required for large scale purification of therapeutic proteins, strict demands are placed on the chromatographic particles so as to attain economically viable throughput. These columns must be capable of attaining relatively fast flow rates with reasonably low pressure drops. In general, a superficial velocity (or linear flow rate) of at least 150 cm/hr is desired, with flow rates of 500 to 1000 cm/hr being preferred, at differential pressures of less than 200 psi (1380 kPa) and preferably less than 50 psi (345 kPa), to achieve reasonable throughput. These pressure/flow requirements dictate that useful chromatography resins must be quite rigid (e.g., have low compressibility under the flow rates utilized in the column), must be of relatively large average size (e.g., above about 50 to 150 micrometers particle diameter), and must have a relatively narrow size range distribution (e.g., must be classified to remove fines and large particles to allow ease of packing in the column without generation of channeling, etc.).

In practice, however, pressure/flow testing in a 1 cm diameter column can be indicative of practical utility in a large, process scale column. For example, a resin that supports a particular flow rate at 50 psi in a 1 cm diameter column typically will only support a flow rate of 30-40% of that value when packed in a 10 cm or larger diameter column (at the same bed height). It is generally believed that a resin, when packed in a 1 cm by 10 cm column, must support>300 cm/hr flow rate (4 ml/min) at 50 psi (0.34 MPa), preferably>600 cm/hr at 50 psi, to have any utility for process scale chromatographic bioseparations.

A wide variety of chromatographic particles are available commercially for the purification of biological molecules. A good description of many of these resins, and their compositions, is provided in “Immobilized Affinity Ligand Techniques”, G. T. Hermanson, A. K. Mallia, and P. K. Smith, Academic Press, NY, 1992, pp. 1-41. While most of these materials are useful for analytical scale separations, only select ones have been found to be useful on the process or large scale. For example, supports based on the natural polysaccharides agarose and cellulose have desirable properties of hydrophilicity, high capacity, low nonspecific binding, etc. To be useful in process scale, agarose materials must be crosslinked at fairly high levels (e.g., 6% or more) in order to attain the rigidity necessary to support reasonably high flow rates. However, the crosslinking process results in decreased capacity. Polyacrylamide based supports have the advantageous properties of good pH stability, excellent chemical stability, low nonspecific binding, and resistance to microbial attack, but in general are very soft and will usually only allow flow rates of a few cm/hr. Sephacryl supports, based on a composite of the polysaccharide dextran and synthetic monomer, are also good supports for small scale purifications but generally suffer from low flow rate due to their soft, compressible nature.

In one embodiment, the present invention provides a composite filtration medium that allows the use of soft, compressible stationary phases for efficient large scale bioseparations. Such composite filter medium provides high capacity, high throughput, and good flow rates using the soft particulates. As used herein, “soft” refers to particles that may be deformed at least 10% along the axis of an applied force. For spherical beads, such soft particles will undergo at least a 10% change in the aspect ratio of the particle. For example, a soft spherical bead having an initial aspect ratio of I in a chromatographic column under a pressure of at least 50 psi (0.34 MPa), will be deformed to an aspect ratio of 0.9 or less.

Chromatographic resins based on inorganic and organic polymers can be prepared which are quite rigid and able to withstand high pressures. However, particle size and particle size distribution are also very important parameters in attaining high linear flow rates needed for process scale packed bed columns. While small particles (e.g., particles of diameters less than about 50 micrometers) can be advantageous on the analytical scale, they can lead to very high back pressures (e.g., 100's to 1000's of psi). Since such pressures cannot be tolerated on the process scale, the manufacture of these particles usually include a classification or particle sizing operation to remove the “fines” or small particles. Large, or oversize, particles are removed so as to provide a relatively narrow particle size distribution for uniform packing and flow distribution in column format. This classification process results in decreased yields and increased manufacturing costs for the resins, and ultimately leads to an increased cost for the biopharmaceutical end product. Other rigid matrices, such as controlled pore glass, are very brittle and thus must be handled very carefully to avoid fracture and grinding of the particles, which would generate fines that would be detrimental to the pressure/flow properties on large scale.

The present invention overcomes problems in the art by providing a composite filtration medium that allows the use of stationary phases having average particle sizes less than 50 micrometers, and preferably less than 30 micrometers, for efficient large scale bioseparations. Such composite filter medium provides high capacity, unexpectedly high throughput, and good flow rates with low pressure drop using these particulates. The present invention also allows the use of unclassified resins for efficient large scale bioseparations.

In another aspect, the invention provides a method of separating (which can include purifying) a biomacromolecule comprising the steps of providing a separation system containing a filter cartridge comprising a composite filter medium on the upstream surface of which are located stationary phase particulates capable of binding with a biomacromolecule so as to selectively bind the biomacromolecule (or more than one biomacromolecule in the case of related biomacromolecules) to the stationary phase particulate so as to form a biomacromolecule:stationary phase particulate product. Preferably the filter cartridge is a dead end filter cartridge. The method used may include a reservoir containing a solution comprising at least one biomacromolecule as solute, and a pump and associated tubing, preferably to form a closed loop assembly, and pumping the solution through the filter cartridge, and optionally, pumping an eluting solution through the closed loop assembly which is capable of reversing the biomacromolecule:stationary phase particulate product binding interaction so as to liberate the biomacromolecule. In another aspect, there is provided a filter cartridge including the composite filter medium.

In yet another aspect, there is provided a separation filter assembly comprising the filter cartridge and a filter cartridge housing, the stationary phase particulate of the composite filtration medium of the invention being capable of binding a biomacromolecule. Further, this invention provides a method for separating, purifying, or concentrating a biomacromolecule solute from a solution containing other biomacromolecular solute compounds. The method is conducted at relatively low pressure and is especially suitable for large-scale bioseparations.

More particularly, the method of the invention provides a liquid filter cartridge comprising a composite filter medium contained within a suitable housing that is connected to a pump and a solution reservoir. The composite filter medium may be prepared by a process in which a slurry comprising at least one of adsorption, ion exchange, affinity, and hydrophobic stationary phase particulates in a liquid (generally water) is pumped through to partially load a filtration layer such that the stationary phase particulates are principally located on the upstream surface of the porous filtration layer. A solution of a biological mixture to be separated is then pumped through the filter cartridge in order for the biological solute of interest to be separated from the solution by a binding association with the stationary phase. The procedure is commonly performed to recover the separated (i.e. bound) biological solute.

During elution or an isolation step, a solution that can effect reversal of the binding to the stationary phase is next pumped through the filter cartridge, preferably in a volume of solution smaller than the initial volume of the biological solution mixture. Binding of the selected biomacromolecule solute from a solution that passes through the filter element can be by sorption or chemical interaction. Preferred binding mechanisms include adsorption, ion exchange, hydrophobic association, and affinity binding. In a separate step, the binding can be reversed so as to isolate and purify the previously bound biomacromolecule.

In this application:

“biomacromolecule” means a component or product of a cell such as a protein, carbohydrate, lipid, or nucleic acid, possessing a molecular weight of at least 500;

“filtration layer” means a sheet-like woven or nonwoven porous material which can comprise one or more individual layers which can be combined to provide a single sheet; the average pore size is greater than 1 micrometer and up to 50 micrometers;

“composite filtration medium” or “composite filter medium” means a filtration layer comprising a layer of stationary phase particulates located on the upstream surface thereof; the medium can sustain a flux rate of at least 0.01 cm/min at a filter cartridge pressure of at most 0.25 MegaPascals (MPa), a “composite filtration medium” comprises one or more filtration layers and a sorbent particulate layer disposed on the upstream surface thereof configured for fluid passage; it is the actual component of a separation filter assembly which accomplishes the filtering/separating/purifying operation;

“target molecule” refers to one or more chemical species for which the composite filtration article described herein is designed to separate from a liquid feed stream or solution mixture feed stream. Target molecules can include, for example, pharmaceutical species, biomacromolecules such as, proteins and antibodies (monoclonal or polyclonal), DNA, RNA, expressed by bacterial, yeast, mammalian, plant, or insect cells, minerals, and manmade chemical species such as, for example, synthetic small organic molecules, peptides and polypeptides, oligosaccharides, and sugar modified proteins. In some embodiments, the target molecule can be one or more impurities or waste products, including proteins, inorganic species such as metals, metal ions, or ions such as carbonates, sulfates, oxides, phosphates, bicarbonates, and other ions commonly found in industrial, residential and biological feed streams, small organic molecules such as those that comprise, but are not limited to, dyes, pesticides, fertilizers, additives, stabilizers, process byproducts and pollutants, DNA, RNA, phospholipids, viruses, or other cell debris from a bioprocess. In still a further embodiment, leached ligands such as, for example, Protein A or other affinity ligands from an upstream affinity separation process could also be a target molecule. In other embodiments, the composite filtration article described herein could be used to remove various chemical or biological species from a waste or drinking water stream, either via adsorption or enzymatic reaction, for example. “filter cartridge” means a filtering device onto which the stationary phase particulates may be loaded;

“filter cartridge housing” means a support structure for a filter cartridge;

“macroporous” refers to particles that have a permanent porous structure even in the dry state. Although the resins can swell when contacted with a solvent, swelling is not needed to allow access to the interior of the particles through the porous structure. “gel-type resins” or “gels” do not have a permanent porous structure in the dry state but must be swollen by a suitable solvent to allow access to the interior of the particles. Macroporous and gel particles are further described in Sherrington, Chem. Commun., 2275-2286 (1998). The macroporous ion exchange resins typically have pores with a size of 20 to 3000 Angstroms (i.e., the pore size can be characterized using nitrogen adsorption at various relative pressures under cryogenic conditions or by mercury intrusion porosimetry).

“separation filter assembly” means a housing containing a filter cartridge, preferably a dead end filter cartridge, comprising a composite filter medium on the upstream surface of which are located stationary phase particulates;

“separation system” means a solution mixture comprising at least one biomacromolecular solute contained in a reservoir, a separation filter assembly or chromatographic column, a pump, and associated tubing;

“separation device” means a container comprising at least one means of fluid passage through the device and a means of retaining stationary phase particulates within the device;

“flux rate” means the velocity of a liquid stream passing through a filtering element and is equal to flow rate divided by the cross-sectional surface area of the filtration layer. Described in this way, flow of a liquid stream can be characterized and is independent of the size of the filtration layer. Flux rate also contributes to pressure drop across a filter, i.e., increased flux rates generally mean increased system pressures. In commercial filter cartridge applications, it is highly desirable to provide a filter of minimum size which will process a maximum amount of liquid stream. Therefore, it is desirable that flux rate be increased by increasing the flow rate;

“stationary phase particulates” mean insoluble particulates that can form a binding association with a component of interest in a solution mixture. Specific binding associations include: adsorption, ion exchange, hydrophobic, and affinity interactions;

“insoluble” means not more than I part particulates dissolves in 100 parts of solvent at 23° C.; and

“filter cartridge pressure” means the difference between inlet, or upstream, and outlet, or downstream, pressures across the filter cartridge unit in a separation system.

The present invention process overcomes problems of prior art filters comprising conventional macroporous particulates employed for the separation of biomacromolecules. Prior art filters containing stationary phase particulates within a filtering element present manufacturing challenges and offer only limited capacities. Higher loading of particulates gives rise to a filtering element with reduced porosity and concomitant increased operating system pressures. The present invention overcomes these problems of prior art filters by providing high loading capacity of particulates at relatively low filter cartridge pressures.

### BRIEF DESCRIPTION OF THE DRAWING

FIG. 1 is a schematic illustration of a cross-section of a composite filtration medium comprising a filtration layer which comprises a layer of stationary phase particulates located on the upstream surface thereof;

FIG. 2 is a perspective view of the embossed pattern on a composite filtration medium of the invention;

FIG. 3 is a perspective view of a cylindrically pleated filter element of the invention;

FIG. 4 is a perspective view of support members for a cylindrical filter cartridge of the invention;

FIG. 5 is a perspective view of a separation filter assembly of the invention;

FIG. 6 is a schematic illustration of a separation system of the invention;

### DETAILED DESCRIPTION OF THE DRAWING

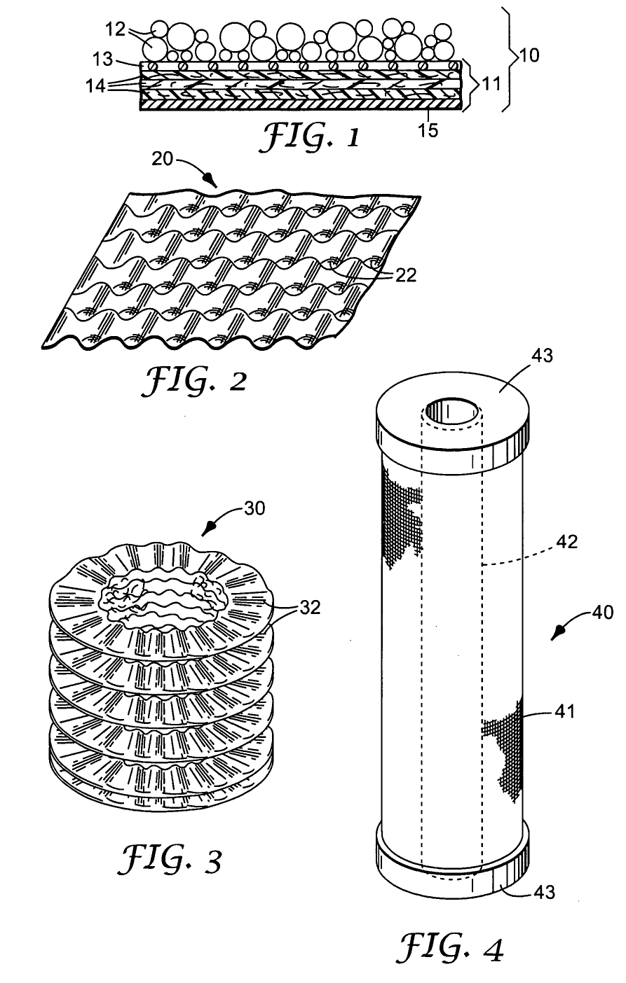

FIG. 1 is a schematic illustration of a cross-section of a composite filtration medium 10 comprising a preferred nonwoven web as surface filtration layer 11 which can be one or more individual layers, upon the upstream surface of which are located insoluble stationary phase particulates 12. The nonwoven filtration layer 11 which possesses uniform porosity and well-defined pores can comprise coarse upstream prefilter layer 13, filtration layers 14 comprising a multiplicity of nonwoven filtration layers having increasingly finer downstream porosity, and a downstream nonwoven cover layer 15.

FIG. 2 is an illustration of a preferred embodiment of the invention. There is shown a perspective view of a nonpleated portion of a pattern of embossed shapes 22 on composite filtration medium 20 utilized to produce filter cartridges. Embossing is conducted to increase frontal surface area and more completely define the surface filtering element. The insoluble stationary phase particulates are omitted from the illustration for clarity.

FIG. 3 is a perspective view of a longitudinally extended cylindrically pleated filter element 30 of a preferred embodiment of the invention; radial pleats 32 of preferred compound radially pleated filtration element 30 of the invention are shown; again, stationary phase particulates are omitted for clarity.

FIG. 4 is a perspective view which illustrates inner and outer supplemental support members for cylindrical filter cartridge 40, which is a preferred embodiment of the invention. External support structure 41, such as a scrim or screen with a multiplicity of holes, can provide additional support in an inward-out fluid flow mode to reduce the likelihood of rupturing the filter element. Similarly, inner support structure 42 consisting of a scrim or screen, or a porous casing or similar construction can provide support to prevent the filter element (not shown) from collapsing under high pressure applications in a preferred outward-in fluid flow situation. In both cases, the supplemental support structures are normally attached to endpieces 43 of the filter cartridge to provide an integral unit.

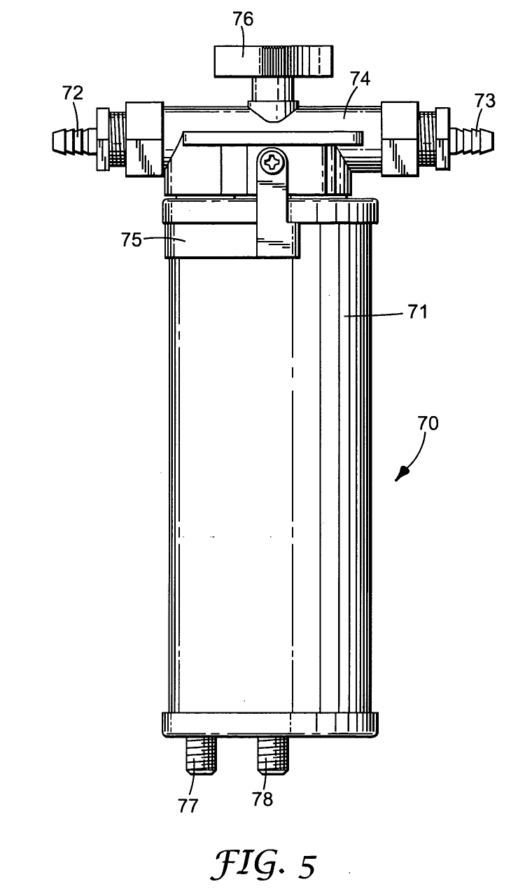

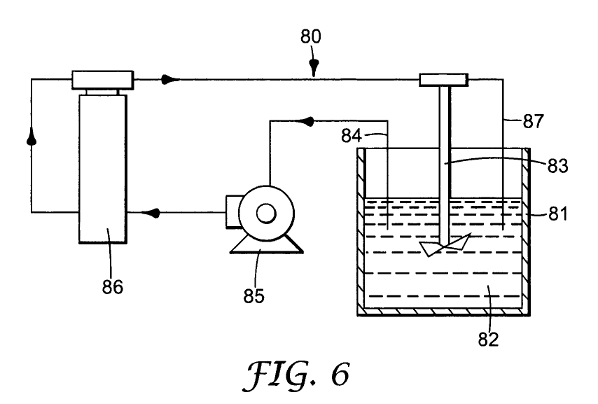

FIG. 5 is a perspective view of a separation filter assembly 70 of the invention, this being a preferred embodiment of the invention. Filter housing 71 contains a filter cartridge (not shown). In the separation loop, inlet port 72 allows the solution mixture to enter the filter cartridge in the preferred outward-in mode. The liquid exits separation filter assembly 70 through outlet port 73. In a preferred assembly, the separation head 74 is attached to filter housing 71 by a mechanical clamp 75 employing a threaded bolt (not shown) with tension adjusting control knob 76. In the isolation loop, inlet port 77 allows de-binding solution to enter the filter cartridge in the preferred outward-in mode, and the resultant solution now containing the desired biomacromolecule solute exits separation filter assembly 70 through outlet port 78.

FIG. 6 is a schematic illustration of a separation system 80 of the invention. Reservoir 81 contains aqueous stationary phase particulate slurry 82 and/or biomacromolecule solution mixture 82, with stirring being provided by stirring apparatus 83. Slurry or solution 82 is pumped from outlet tube 84 by pump 85 through separation filter assembly 86 (which contains stationary phase particulates located on the upstream surface of the filtration layer of a filter cartridge (not shown)) and back into the reservoir via inlet tube 87 (arrows show direction of liquid flow).

### DETAILED DESCRIPTION

This invention provides an article and method of isolating and purifying a biomacromolecule comprising a separation filter assembly including a composite filter medium which incorporates stationary phase particulates, which can bind to a biomacromolecule, on the upstream surface of a filtration layer. In another embodiment, this invention provides a method for large-scale bioseparations that employs a separation device comprising stationary phase particulates that can bind to a biomacromolecule on the upstream surface of a filtration layer. The stationary phase particulates may comprise organic or inorganic particles having an average diameter of less than 50 micrometers, soft particulates, and crushed porous monolithic materials.

The separation filter assembly comprises a liquid filter cartridge that includes the above-described composite filter medium and a suitable cartridge housing for the filter element connected to a reservoir of solution comprising one, or preferably two or more biomacromolecules. The filter cartridge is connected by suitable tubing to a pump capable of passing the solution, which can include a selected biomacromolecule to be separated by binding to particulate or an eluting solution to release the bound biomacromolecule, through the composite filter medium and back into the reservoir so that the resultant solution can be repeatedly cycled through the composite filter medium for further capture of the free biomacromolecule to complete the separation, or, if desired, to elute the bound biomacromolecule. The article and method are useful in large-scale bioseparations.

More particularly, the invention provides a method of separating or purifying a biomacromolecule, the method comprising the steps of:
1) providing a separation system containing a filter cartridge (preferably a dead end filter cartridge) comprising a composite filter medium, on the upstream surface of which are located stationary phase particulates (as described herein) capable of adsorption, ion exchange, hydrophobic, or affinity binding with a biomacromolecule, a reservoir containing a solution mixture comprising one or more than one biomacromolecule solute, a pump and associated tubing (preferably to form a closed loop system);
2) pumping the solution mixture through the filter cartridge assembly to accomplish binding of the selected biomacromolecule to the stationary phase particulates (optionally with recirculation), the pumping through the filter element being conducted with a flux rate of at least 0.01 cm/minute, preferably at least 0.10 cm/minute, and more preferably at least 0.30 cm/minute at a filter cartridge pressure of at most 0.34 MPa, preferably at most 0.25 MPa;
3) optionally, washing the biomacromolecule:stationary phase particulate product with suitable liquid to remove unwanted biomacromolecules and other solutes not bound to the stationary phase particulates by the selected adsorption, ion exchange, hydrophobic or affinity binding interaction, in an open loop or one pass procedure; and
4) optionally pumping, preferably a decreased volume (compared to the original solution mixture volume), of a debinding solution which will reverse the biomacromolecule:stationary phase particulate binding interaction to liberate the separated and purified biomacromolecule.

Removal of particulates by filtration of liquid streams may be accomplished by applying one or a combination of the following filtration mechanisms, and liquid filter cartridges are presently commercially available that operate by each mechanism. The present invention utilizes these filtration mechanisms whereby the filtration layers retain stationary phase particulates in a flowing separation system:
i) Depth Filtration—This procedure is one in which a particulate-containing liquid stream is confronted by a filter element possessing a distribution of sized holes or pores and offers the particulates a rather tortuous pathway through the filtration layer. In the prior art, particulates were chiefly removed by adsorption and/or entrapment within the filtration layer itself. Depth filtration, often the coarse or first filtration procedure applied to a system and one designed to remove particulates having a size from hundreds of micrometers (in diameter-largest dimension) to about 1 micrometer, suffers problems of incomplete removal of particulates due to ill-defined pore sizes and steady, rapidly increasing filter cartridge pressures as the filter becomes loaded.
ii) Surface (Cake) Filtration—This procedure is preferred in the present invention and often occurs subsequent to depth filtration in the treatment of a liquid stream. In the prior art, it is generally conducted using multiple layers of glass or polymeric microfibers that possess well defined pore sizes, and the particulates generally do not penetrate within the filtration layer but remain trapped on the upstream surface of the layer. Particulate sizes down to about 0.1 micrometer may be loaded with high efficiencies. High flux rates are readily achievable, and relatively large quantities of particulates are loaded at relatively low system pressures until the filter is nearly full. In the present invention, it may be advantageous to load or realign the filtered particles on the surface of the filtration layer by multiple reverses of the liquid flow; this opportunity does not exist with depth filters.
iii) Membrane (Screen or Sieving) Filtration—This filtering mechanism is very similar to surface filtration, except that precisely defined, very small pores are present that are capable of loading particulates with sizes as low as 0.05 micrometers.

The present invention may be used in tangential flow and “dead-end” cartridge filters. In tangential flow or radial membrane cartridge filters, the filtering element is presented in a plane parallel to the liquid stream flow, and two effluents or permeates are produced: one filtered (or processed by passing through the filtering element) and another not. While these filter arrangements operate at low pressures and the unprocessed permeate can in theory be recycled, these systems are intrinsically more complicated and slower to completely process a liquid stream because of relatively low flow through the element; also, if filtering elements were modified in some fashion to retain biomacromolecules, complete retention would be required in one pass through the element.

In “dead end” filters, all the liquid stream is required to pass through the element and only one permeate is produced. Considered as a separation unit in which separation is occurring by interaction with a stationary phase on or within the filtering element, the dead end cartridge filter would be analogous to a very wide, but shallow column. At high flow rates, single pass retention of the biomacromolecule may be relatively low but by repeatedly cycling, the effluent high percentages of the biomacromolecule can be retained.

Useful surface filter cartridges in the present invention include the standard vertical pleated filters of U.S. Pat. No. 3,058,594 and, especially preferred, the horizontal, compound radially pleated filters of U.S. Pat. No. 4,842,739, all incorporated herein by reference as useful particle loadable filter cartridges for the present invention. A horizontal arrangement of pleats (as shown in FIG. 3) is preferred in the present invention because the filter cartridges are generally employed vertically, and a greater percentage of particles is retained within the horizontal pleats when flow is discontinued and the cartridge stored between uses. The horizontal arrangement of pleats generally allows the packing of a greater amount of filtration layer surface area into a cartridge, thus leading to a greater capacity for loading with particulate than in the case of a vertically pleated cartridge. Other filter cartridges such as string wound, resin bonded, and spray spun depth filters may also be utilized but generally lack the ability to accept as much particulate as the surface filters while at the same time maintaining relatively low system pressures.

Standard cylindrical, vertically pleated filter cartridges are available from Ametek/US Filter (Warrendale, Pa.) in a variety of sizes with filter element materials, e.g., cellulose, cellulose-polyester, glass-cellulose, polyester, polypropylene, and ceramic, and having average nominal pore sizes, e.g., 1, 2, 3, 5, 10, 20, 30, and 50 micrometers. Preferred cylindrical, compound horizontally radially pleated surface filter cartridges of all-polypropylene construction can be purchased from 3M Filtration Products (St. Paul, Minn.) in a variety of sizes and possessing average nominal pore sizes of 2, 5, 10, and 20 micrometers. Smaller disposable capsule filters that are useful for smaller scale separations are available from Pall Corporation (East Hills, N.Y.) in a variety of sizes with filter element materials, e.g., polyamide such as acrylic coated nylon and polypropylene, and average nominal pore sizes, e.g., 1, 3, and 5 micrometers.

While the binding (separation step) and elution or debinding (isolation step) interactions can be conducted using filter cartridge housings available from filter cartridge manufacturers, these housings generally possess only one set of inlet and outlet ports. As a consequence, it is difficult to accomplish the highly desirable concentration of the purified biomacromolecule when the debinding solution is introduced. A preferred filter cartridge housing possesses an additional set of inlet and outlet ports of smaller size. This set of smaller ports can advantageously be utilized to accomplish debinding of the biomacromolecule, generally in a significantly reduced total volume of solution so that the purified biomacromolecule is obtained in a more concentrated solution in the process as well.

Preferably, the composition of the filtration medium of the present invention comprises one or more nonwoven layers on the upstream surface on which are randomly disposed insoluble stationary phase particulates. From a mechanical standpoint and with regard to solvents employed, compositions of filtration media are not critical when conducting bioseparations because water is utilized almost exclusively, and essentially all of the above-specified filtration layer materials generally perform well in water. A preferred material because of its availability, cost, and inertness is polypropylene.

Selection of the pore size of the filtration layer depends directly on the size range of the stationary phase particulates to be retained on the upstream surface thereof and generally corresponds with the smallest particulate size. It has been determined, however, that even if a portion of the particulates possess sizes smaller than the pore size of the filtration layer useful composite filtration media can be obtained. These smaller particulates will pass through the filtering element in early cycles, in later cycles as a bed of particulates accumulates the device takes on the nature of a depth filter, and these smaller particles can also be removed and utilized in the invention. In the interests of time efficiency and utilizing the filter cartridge in the preferred surface filtration mode, however, it is preferable to utilize a surface filter cartridge unit wherein at least 95% of the stationary phase particulates are removed in the first pass through the filter.

Generally a filter cartridge rated nominally at an average of 0.1-10 micrometers meets these criteria and provides an efficient filtering element for the particulates utilized in the invention and also is capable of delivering relatively high flux rates at low filter cartridge pressures. Filtration layers with average pore sizes less than 0.1 micrometer such as porous, nonfibrous membranes are not generally useful because they are susceptible to plugging, not only from adventitious particles that may be present but even by suspended biological material which is often encountered in highly concentrated biological solution mixtures.

For purposes of this invention, stationary phase particulates bind or strongly associate with the biomacromolecules of interest in solution mixtures by one or a combination of the following interactions: adsorption, ion exchange, hydrophobic association, and affinity binding. More than one type of active sorbent particles useful in the present invention can be pre-mixed in any proportion.

The sizes of the stationary phase particulates useful in the invention can range from a distribution in which a small portion, e.g., less than 5%, are submicrometer (largest average diameter) to as large as several millimeters for crushed monolithic particulates, as large as 1000 micrometers for soft particulates, and as large as 50 micrometers for hard inorganic or organic particulates, depending on the nature of the filter cartridge employed.

Particle sizes of soft stationary phase particulates are preferably in the range of submicrometer to 400 micrometers, more preferably 1-200 micrometers, and most preferably 5-100 micrometers in diameter. It has been found advantageous in some instances to employ particulate materials in two or more particle size ranges falling within the broad range. Any of the hard or soft particulates may have a spherical shape, a regular shape or an irregular shape. Crushed monolithic particulates have an irregular shape.

Using the composite filter medium of the invention, hard particulate sizes of less than 50 micrometers may be used. In some embodiments, particles sizes of less than 30, 20 or 10 micrometers may be used. Heretofore, such “fines” were not considered useful due to the high pressures encountered during packing and using the column. The instant composite filters allow such fines to be used for large scale bioseparations, and at pressures typically less than 0.34 MPa. In particular, particles sizes of less than 50 micrometers may be advantageously used because smaller diameter particles have a smaller diffusional barrier in the adsorption process. Thus, incorporation of small particles into the separation device of the present invention can result in faster capture kinetics and an overall increased throughput in the bioseparation process.

In some embodiments, particles useful in the present invention have high water sorptive capacity compared to particle weight. Heretofore, particles that undergo dimensional changes due to water swellability or buffer or pH changes were considered less desirable because they can cause dimensional changes during use. This is particularly undesirable in packed chromatography columns as it can lead to dramatic changes in pressure, can cause channeling, or can restrict flow. It has been found that such dimensional changes, typical of soft gel particulates, do not cause adverse effects in the separation devices of the present invention. Further, it has been found, to the contrary that such soft, gel particulates may have higher capacities than conventional chromatography particles.

An important attribute of the present invention is that utilizing a particulate support possessing a relatively high concentration of functional groups involved in the binding interactions with the biomacromolecule of interest can generally separate a greater quantity of the selected biomacromolecule. With support particulates, a relatively high surface area is desirable to provide a high concentration of available functional groups. Preferably, the surface area of particulates is at least 10 m²/g, more preferably at least 50 m²/g, and most preferably at least 100 m²/g, and even up to 5000 m²/g (as determined by gas adsorption measurements). With soft or gel type particulates, the concentration of functional groups can often be increased by lowering the crosslink density, which also results in soft particles. The optimal crosslink density will depend on the chemical composition of the particulate material. For example, with agarose based supports, crosslink densities less than 6% will provide supports with higher functional group densities and concommitant higher biomacromolecule capacities. With acrylic and styrene based particulates, crosslink densities of less than 20% will allow the incorporation of greater amounts of the appropriate functional groups.

Various interactions between solutes and stationary phase particulates can involve relatively weak attractive forces such as dipole-dipole, ion-dipole, and ion-ion interactions. What makes biomacromolecules having a molecular weight of at least 500 efficiently bound in the present invention is that several of these interactions occur over the relatively large area of contact between biomacromolecule and stationary phase, resulting in a net strong attractive force.

Adsorption separation utilizes the binding association of polar groups on a stationary phase and the wide diversity of polar groups on biomacromolecules. These binding associations are generally of the form of dipole-dipole and ion-dipole interactions. The binding or separation phase of the purification operation is usually conducted from an aqueous buffered solvent of relatively low ionic strength so that the above-mentioned binding associations between stationary phase and biomacromolecule solute can be maximized to effect binding. After washing with a buffered aqueous solution of low ionic strength, the eluting solution commonly employed contains a relatively large amount of dissolved salts and a concomitant high ionic strength so that interactions between the stationary phase and the dissolved salts will displace the biomacromolecule from the stationary phase, and the biomacromolecule will re-dissolve and can be recovered in purer form from the separation system.

Preferred adsorption stationary phase particulates include hydroxyapatite, alumina, and zirconia (disclosed in U.S. Pat. No. 5,015,373 and incorporated by reference). Ion exchange separations take advantage of the fact that many biomacromolecules are ionically charged. Furthermore, many of these ionically charged groups, e.g., protonated amine and carboxylate, can be rendered neutral and uncharged by a change in pH. This provides a sensitive and very powerful technique for separation of biomacromolecules based on their isoelectric points, often indicated by a pI value which is the pH at which charge neutrality exists or the number of negatively charged groups and positively charged groups within a molecule is the same. If the pH is maintained above pI, then an anion exchange resin can be used to bind the biomacromolecule; conversely, if the pH is lower than pI, a cation exchange resin can effect binding and removal of the biomacromolecule from the solution mixture. With this technique even small differences in accessible or surface charges on biomacromolecules can result in effective separations. After washing the insolubilized biomacromolecule:stationary phase particulate product, elution of the bound biomacromolecule from an ion exchanging stationary phase particulate is generally conducted by introducing a relatively high concentration of a salt solution whose corresponding ions will exchange with and displace the biomacromolecule from the stationary phase particulate. Alternatively, elution can be accomplished by a change in pH of the eluting solution. Such hard, inorganic particulates may have an average particle diameter of less than 50 micrometers, preferably less than 30 micrometers.

The polymeric matrix of particulates may contain a variety of substances, including but not limited to cross-linked agarose, cross-linked polystyrene, hydrophilic polyether resin, acrylic resin, and methacrylate based resin. The ion exchanger functional group component may comprise, but is not limited to, a cationic exchanger selected from the list consisting of sulfopropyl cation exchanger, a carboxymethyl cation exchanger, a sulfonic acid exchanger and a phosphonic acid exchanger. In other embodiments, the ion exchanger component may comprise, but is not limited to, an anionic exchanger selected from the list consisting of diethylaminoethyl (DEAE), trimethylaminoethyl (TMAE), and dimethylaminoethyl (DMAE). Some embodiments may include combinations of cationic, anionic and hydrophobic interactions.

Useful anion exchanging resins feature agarose, dextran, and cellulose polymers that have been modified to contain tertiary and quaternary ammonium groups. Cation exchanging resins feature the same base polymers but possessing carboxylate and sulfonate groups.

Useful ion exchange resins may be prepared by the general techniques described in Meitzner et al., U.S. Pat. Nos. 4,501,826, 4,382,124, 4,297,220, and 4,224,415 (each incorporated herein by reference). In some embodiments, lesser amounts of crosslinking agent are used—sufficient to produce gel particulates, rather than the described macroporous particulates. The amount of crosslinking agent is that which will provide a degree of swelling greater than 0.5, and is generally less than 20 parts by weight, based on 100 parts total polymer. Useful ion exchange resins based on acrylamide-type monomers are disclosed in Assignee's copending patent application U.S. Ser. No. 10/849,700, (Rasmussen et al., now allowed) incorporated herein by reference.

Hydrophobic interaction and reverse phase chromatography utilize the hydrophobicity of many biomacromolecules. Interaction of hydrophobic portions of a biomacromolecule with hydrophobic functional groups of a stationary phase particulate results in a binding association and separation of the biomacromolecule from the solution mixture. The procedure is commonly conducted by binding from an aqueous solution of relatively high ionic strength. In this fashion the biomacromolecule is somewhat precariously soluble to begin with by being almost “salted out” of solution and will readily bind to a hydrophobic solid support. Elution is commonly conducted by employing an aqueous solution of reduced ionic strength (and increased solvent efficiency for the biomacromolecule); alternatively, organic solvents such as acetone, acetonitrile, ethanol, methanol, and N,N-dimethylformamide in amounts up to 50 weight percent may be employed with water as co-solvent to remove the biomacromolecule from the insoluble complex with the stationary phase particulate.

Useful hydrophobic interaction stationary phase particulates include, but are not limited to, agarose based supports and acrylic supports modified by inclusion of, for example, butyl, octyl, and phenyl groups. Useful reverse phase particulates include, but are not limited to, styrene-divinylbenzene supports and organosilane-modified silica supports.

Affinity chromatography operates generally by covalently binding a ligand or biospecific effector to a stationary phase particulate. This ligand or effector is chosen because of its ability to interact with a biomacromolecule by a “lock and key” relationship. If a protein, for example, is the biomacromolecule whose separation is desired, the covalently bound ligand or effector is often a substrate or inhibitor (“key” molecule) that binds strongly to the active site (the “lock”) of the protein. The high selectivity of this process allows for one-step purification of a biomacromolecule from a complex mixture. Although elution is often accomplished by a simple change in pH, debinding solutions and techniques are specific for each biomacromolecule-ligand pair, and specific instructions can be obtained from the manufacturer.

Useful affinity chromatography stationary phase particulates have a variety of base matrices including agarose, cellulose, and vinyl polymers possessing several ligands (with corresponding biomacromolecule affinities) including: arginine and benzamidine (serine proteases), Cibacron Blue (enzymes requiring adenyl-containing cofactors, albumin, coagulation factors, interferon), calmodulin (ATPases, protein kinases, phosphodiesterases, neurotransmitters), gelatin (fibronectins), glutathione (Stransferases, glutathione-dependent proteins, fusion proteins), heparin (growth factors, coagulation proteins, steroid receptors, restriction endonucleases, lipoproteins, lipases), Proteins A and G (IgG and subclasses), L-lysine (plasminogen, plasminogen activator, ribosomal RNA), procion red (NADP⁺ dependent enzymes, carboxypeptidase G), concanavalin A and lectins (glycoproteins, membrane proteins, glycolipids, polysaccharides), and DNA (DNA polymerase, RNA polymerase, T-4 polynucleotide kinase, exonucleases).

Using the composite filter medium of the invention, stationary phase particle sizes of less than 50 micrometers may be used. Heretofore, such “fines” were not considered useful due to the high pressures encountered during packing and using the column. The instant composite filters surprisingly allow such fines to be used for large-scale bioseparations at pressures less than about 50 psi (0.34 MPa). Further, soft particulate gels may be used. Heretofore, soft particulates were not considered useful for preparatory separations due to the deformation of the gel particles and resulting high pressures and/or low flow rates.

In a preferred embodiment, crushed or ground monolithic resins may be used as the sorbent stationary phase particulate. In traditional monolithic materials, a chromatographic column is charged with the requisite monomers and a porogen, and polymerized in situ to produce a solid, continuous plug of resin. This procedure has heretofore only been applicable to separations in relatively small-scale columns.

Applicants have discovered that these monolithic materials may be prepared in a suitable vessel to produce a plug, and then ground to produce irregularly shaped particles. These particles, as produced, have a relatively broad particle size distribution (generally about 0.1 to 1000 micrometers), which may be used in the composite filter of the invention. In this manner, the unique porosity and kinetic adsorption properties of monolithic materials can be adapted to large-scale bioseparations. If desired, the ground, irregularly shaped particles may be classified by size, or may be used as produced. Heretofore, regularly shaped (i.e. spherical) particles, which are produced by suspension polymerization, were classified to narrow range of particle sizes and/or to remove the fines. Such fines, if not removed, would pack the interstitial spaces between larger particles, reducing the flow and/or significantly increasing the pressure. Unclassified, ground monolithic particles require no such classification or removal of fines and may be used in the composite filter of the invention while maintaining adequate flow and avoiding high pressures in excess of 50 psi (0.34 MPa).

The polymeric monolith is made of monomers present in a mixture that is suitable for in situ polymerization resulting in formation of such porous monolithic polymer. Such mixture comprises, for example, a monomer or a mixture of monomers, porogen, and an initiator.

Typically, the polymeric monolith comprises polymerized monomer units bearing a hydrophilic group, a precursor of a hydrophilic group, an ionizable group or a precursor thereof, a hydrophobic group or a precursor thereof, or their mixtures. Optionally, the polymeric monolith may also contain an affinity ligand. Any combination of the above monomer units is intended to be within the scope of the invention.

In the porous polymer monoliths which comprise polymerized monomer units bearing a hydrophilic group or a precursor to a hydrophilic group, such monomer is generally an acrylate, methacrylate or styrene selected from the group consisting of 2-hydroxyethyl methacrylate, butyl methacrylate, 2-hydroxyethyl acrylate, glycidyl methacrylate, glycidyl acrylate, acetoxystyrene, chloromethylstyrene, t-butoxycarbonyloxystyrene, and a combination thereof.

In the porous polymer monoliths which comprise polymerized monomer units bearing a hydrophobic group or a precursor to a hydrophobic group such monomer is generally selected from the group consisting of acrylate esters, methacrylate esters, acrylate amides, methacrylate amides, styrene, styrene derivatives, and a combination thereof wherein the preferred monomers comprising the hydrophobic group are alkyl acrylates, alkyl methacrylates, styrenes, alkylstyrenes or a combination thereof.

In the porous polymer monoliths which comprise polymerized monomer units bearing an ionizable group or a precursor to the ionizable group such polymerized monomer generally contains a functionality such as an amino group, a carboxylic acid group, a sulfonic and phosphoric acid group (or salts thereof) with a preferred ionizable monomer selected from the group consisting of acrylic acid, methacrylic acid, itaconic acid, maleic anhydride, styrene sulfonic acid, 2-acrylamido-2-methyl-3-propanesulfonic acid, 2-(methacryloxy) ethylphosphate, acrylic amide of amino acid, methacrylic amide of amino acid, 2-vinylpyridine, 4-vinylpyridine, 2-(dialkylamino)ethyl acrylate, 2-(dialkylamino)ethyl methacrylate, 2-(morpholino)ethyl acrylate, 2-(morpholino)ethyl methacrylate, [2-(methacryloxy)ethyl]trimethylammonium chloride, [2-(methacryloxy)ethyl]trimethylammonium methylsulfate, and a combination thereof. Preferred monomers for fabrication of the monoliths are acrylates, methacrylates and derivatives thereof.

The porous polymeric monolith additionally comprises a cross-linking monomer. The cross-linking monomer is a preferably a polyvinyl monomer selected from the group consisting of a diacrylate, dimethacrylate, triacrylate, trimethacrylate, diacrylamide, dimethacrylamide, or a divinylaromatic monomer with preferred polyvinyl monomers being ethylene diacrylate, ethylene dimethacrylate, trimethylolpropane triacrylate, trimethylolpropane trimethacrylate, N,N′-methylene bis-acrylamide, or piperazinediacrylamide, divinylbenzene or divinylnaphthalene.

In one preferred embodiment, the porous polymer monolith comprises from about 10 to about 90% of one or more monovinyl monomers, from about 5 to about 90% of one or more polyvinyl monomers and from about 0.01 to about 2% of the initiator, with respect to the monomers.

The porous polymer monoliths of the invention may optionally also comprise from about 1 to about 50%, of an affinity ligand. The ligand is either covalently immobilized within the already formed monolith or is added to a polymeric mixture before polymerization in a form of a monomer. The ligand may be a biological or a synthetic compound, wherein the biological affinity ligand is selected from the group consisting of polysaccharides, antibodies, enzymes, lectins, antigens, cell surface receptors, intracellular receptors, viral coat proteins, DNA, and a mixture thereof, and wherein the synthetic affinity ligand is selected from the group consisting of reactive dyes, tannic acid, gallic acid, iminodiacetic acid, ethylenediaminetriacetic acid, inert salt of [2-(methacryloyloxy)ethyl]dimethyl(3-sulfopropyl)ammonium hydroxide, and a mixture thereof.

In order to achieve the desired pore structure, polymerization generally includes porogenic materials. Their function is first to dissolve all monomers and the initiator, second to form a homogeneous solution and third to control the phase separation process during polymerization.

Typically, the porogenic material is water, an organic solvent or a mixture thereof The porogenic organic solvent is selected from the group consisting of hydrocarbons, alcohols, ketones, aldehydes, organic acid esters, ethers, soluble polymer solutions, and mixtures thereof such as cyclohexanol, 1-dodecanol, methanol, hexane, propanol, dodecanol, ethylene glycol, polyethylene glycol, butanediol, methyl-t-butylether, diisopropylketone, butanol ethyl acetate, butyl acetate, poly(methyl methacrylate), and mixtures thereof. The porogenic material is typically present in an amount from about 30 vol % to about 80 vol %, with preferred range from about 40 vol % to about 60 vol %.

The monoliths of the invention are fabricated by in situ initiated polymerization. In situ polymerization may be any process or procedure that will effectively polymerize the polymerization mixture into the monolithic structure when such mixture is deposited within a mold or other suitable container. The in situ polymerization process will produce a porous solid monolith. Such process may be initiated by heating, redox reaction or photoinitiation.

Various monolithic polymer materials are known in the art. Reference may be made to Fréchet et al., Adv. Matls., 1999, vol. 11, No. 14, pp. 1169-1181 and references therein, and U.S. Pat. No. 5,453,185, U.S. Pat. Nos. 5,334,310, and 6,887,384 (Fréchet et al.), each incorporated herein by reference. One useful technique for the formation of the polymerized monoliths may be found in U.S. Published Appln. 2004/0166534 (Roscoe et al.), incorporated herein by reference.

Polymerization to the monolithic polymer is generally followed by removal of the porogenic material. The polymerized monolith is then ground or crushed to yield irregularly shaped particles having a size distribution of from about 0.1 to 1000 micrometers. The pore size range depends on the selected polymerization mixture and particularly on use of the porogenic material. The resulting pore sizes are generally less than about 200 micrometers, preferably less than 100 micrometers, and more preferably less than 50 micrometers.

Any suitable grinding or crushing technique may be used, and the polymer may be cooled to below the glass transition temperature to facilitate the grinding.

Having thus described the filter cartridges, filter housings, and stationary phase particulates, the method by which the separation systems are prepared will now be detailed. The process involves the steps of:
i) providing an assembly comprising a filter cartridge comprising a composite filter medium of the invention contained in a housing, and a pump and associated tubing capable of delivering a flux rate of at least 0.01 cm/minute;
ii) introducing a biological solution mixture which comprises at least one biomacromolecular solute in a reservoir so that it can undergo circulation in the separation filter assembly to effect separation of the biomacromolecule.

The composite filter comprising stationary phase particulates having average particle sizes of less than 50 micrometers, soft particulates or crushed monolithic particulates, enables large scale bioseparations, i.e. is capable of separation and/or purification of a biomacromolecule product produced in a bioreactor having a volume of 100 liters or more. In many embodiments, large scale separation of 1000 liters, and 10,000 liters or more are enabled.

Pumps useful in the invention provide flux rates through the filter cartridge in excess of 0.01 cm/minute, preferably in excess of 0.10 cm/minute, and more preferably in excess of 0.30 cm/minute. The pumps and associated gasketing and tubing/piping through which at least one of the slurry and solution mixture comprising more than one biomacromolecule solute flow preferably are relatively chemically unaffected by the solution. Preferred pumps include peristaltic, diaphragm, gear, and centrifugally driven pumps in which the actual pump components contacting the solution are constructed of stainless steel or polytetrafluoroethylene (PTFE). Most types of rubber or plastic tubing/piping are suitable for packings and separations conducted in aqueous media, but if aqueous mixtures of organic solvents are employed, polypropylene, polyethylene, PTFE, stainless steel, and glass tubing preferably are employed. Preferred gasketing materials to interface the connection of the filter cartridges to filter housings and with the rest of the separation system include PTFE and polypropylene.

The filter cartridge may be loaded by a “wet” packing technique comprising the steps of:
i) providing an assembly comprising a filter cartridge comprising a composite filter medium of the invention contained in a housing, and a pump and associated tubing capable of delivering a flux rate of at least 0.01 cm/minute;
ii) providing a slurry of the particulates in an appropriate solvent; and
iii) pumping the slurry through the filter cartridge in a recycling mode until the desired amount of stationary phase particulates has been loaded; preferably the filter cartridge pressure is less than about 0.15 MPa, more preferably less than 0.10 MPa, and most preferably less than 0.05 MPa.

In contrast to conventional “dry” packing manufacturing techniques, “wet” packing the particulates onto the filtration layer by use of a liquid carrier assures that the particulates are located in regions of the filtering element which are subsequently accessible to solution mixtures. The particulates are randomly located on the filtration layer in the sense that their positions are not preselected, although the flow of the liquid carrier may influence the ultimate location of particulates. In packing the filter cartridge by the above process it is desirable to employ fairly dilute concentrations of the particulates in the liquid during each packing session in order to achieve relatively uniform partial loading of the filtering element. The particulates can be added to the reservoir in a portionwise fashion (either without solvent if suitably dense and water-wettable or pre-slurried), with visual clarification of the reservoir contents occurring between each portion.

The flux rate of the packing operation preferably is at least 0.01 cm/minute, more preferably at least 0.10 cm/minute, and most preferably at least 0.30 cm/minute. In addition to separating desired biomacromolecules efficiently with regard to quantity and time during the separation phase, relatively high flux rates are desirable during the particle loading phase especially with the preferred compound radially pleated filter cartridges so that the particulates can better permeate the folds of the pleated filter element, thus accessing more of the filter element and facilitating high loading. The liquid employed to slurry the stationary phase particulates generally is the solvent of the solution mixture and is generally water, preferably buffered water. With hydrophobic interaction or reverse phase stationary phase particulates it may be necessary, especially in the elution step, to utilize organic liquids, in combination with water. Useful organic liquids include methanol, ethanol, isopropanol, acetonitrile, and N,N-dimethylformamide in amounts up to 50 weight percent.

The particulates are loaded into the reservoir and ultimately onto the upstream surface of the filter element until the filter cartridge pressure reaches not more than 0.15 MPa, preferably not more than 0.10 MPa, and more preferably not more than 0.05 MPa. A practical filter cartridge pressure limit for a fully loaded preferred compound radially pleated filter cartridge is about 0.25 MPa. As a general rule of application of filter cartridges, when filter cartridge pressures in excess of about 0.05 MPa are attained, subsequent loading of additional particulates results in increasingly higher filter cartridge pressures. Especially with the lower recommended filter cartridge pressures, however, flux rates of solutions passing through the filter cartridges remain high and in the range desirable for the purposes of this invention. In this fashion, the unit can still respond to adventitious particulates that are likely to be encountered during subsequent separation and handling operations. By reserving some particulate loading capacity for actual operation, shut downs due to filter plugging are averted and filter cartridge lifetimes can be extended.

The stationary phase particulate loaded filter cartridge is now ready to be utilized as a separation filter assembly to separate a biomacromolecule from a solution mixture passed through. The separation filter assembly and cartridge are schematically illustrated in FIGS. 1-5.

After loading the particulates to provide the composite filtration media, the inlet and outlet tubing ends are removed from the reservoir (or left attached if the packing reservoir will also function as separation reservoir) and are attached to a reservoir containing a biological solution mixture. Biological solution mixtures can comprise more than one biomacromolecule solute. The desired biomacromolecule can be derived from fermentation media, cell lysates, and body fluids such as blood and blood components, ascitic fluids, and urine.

It is normally desired to obtain the greatest quantity of purified biomacromolecule in the shortest period of time, i.e., high throughput. High throughput is often quantified in the literature as productivity (or production rate), or the amount of product purified per liter of chromatography resin per hour. Typical productivities of commercially available Protein A resins have been reported by Fahmer, et al., Biotechnol. Appl. Biochem., 1999, 30, 121-128, to be in the range of 13-23 g/L/hr. Using the separation systems of the present invention, capture efficiencies and/or productivities of>25 g/L/hr, >40 g/L/hr, >70 g/L/hr, and>100 g/L/hr are achievable. The velocity with which a solution mixture is passed through the composite filtration medium, i.e., the flux rate, and recycled has been determined to be an important criterion for performance in the present invention. One very important factor is that the present invention separation filter assemblies permit larger volumes of solution mixtures to be processed in a given time primarily because of low pressure operation. Other factors which may contribute to the high efficiencies of the present invention separation filter assemblies are: 1) the ability to utilize smaller stationary phase particulates possessing relatively high surface areas and reduced diffusional limitations compared to larger particles utilized in packed columns; 2) better shear mixing of the biomacromolecule solutes and the stationary phase particulates at higher flux rates; and 3) access to a greater number of particulates contained deeply within pleats or folds of the filtering element at higher flux rates. A flux rate of solution mixture passage of at least 0.01 cm/minute is preferred, more preferably at least 0.10 cm/minute, and most preferably at least 0.30 cm/minute.

The filter elements of the present invention find utility in a variety of biological separations involving proteins, carbohydrates, lipids, nucleic acids, and other biological materials. Separated and purified macromolecules are useful therapeutic and diagnostic agents.

Objects and advantages of this invention are further illustrated by the following examples, but the particular materials and amounts thereof recited in these examples, as well as other conditions and details, should not be construed to unduly limit this invention.

### EXAMPLES

These examples are merely for illustrative purposes only and are not meant to be limiting on the scope of the appended claims. All parts, percentages, ratios, etc. in the examples and the rest of the specification are by weight, unless noted otherwise. Solvents and other reagents used were obtained from Sigma-Aldrich Chemical Company; Milwaukee, Wis. unless otherwise noted.

Test Methods

Cation Exchange Capacity for Lysozyme

A 0.8 by 4 centimeter polypropylene disposable chromatography column (Poly-Prep Column, Bio-Rad Laboratories, Hercules, Calif.) was packed with 1 mL of ion exchange resin. The column bed was equilibrated by washing with 10 mL of loading buffer, a solution of 10 mM MOPS (4-morpholinopropanesulfonic acid) at pH 7.5. The column bed was then loaded with 30 mL of protein solution (chicken egg white lysozyme, approx. 95% purity, Sigma Chemical Co.) having a concentration of 12 mg/mL in the MOPS buffer. All buffer and protein solutions were prepared in deionized water. Any unbound lysozyme was washed off with 30 mL of the MOPS buffer (three 10 mL fractions). Finally, bound protein was eluted with 15 mL of 1 M NaCl in MOPS buffer.

The amount of protein recovered in the various fractions was determined by measuring the UV absorbance at 280 nm using a Hewlett-Packard Diode Array Spectrophotometer, Model 8452A. A standard curve was prepared using pure lysozyme. The amount of protein recovered in the NaCl eluate was equated to the equilibrium cation exchange capacity for the support.

Cation Exchange Capacity for Immunoglobulin G (IgG)

A 50% v/v slurry of cation exchange beads in deionized water was prepared by mixing the beads with water, centrifuging at 3000 relative centrifugal force (rcof) for 20 minutes, and then adjusting the amount of water so that the total volume was twice that of the packed bead bed. The slurry was mixed well to suspend the beads, then a 400 microliter sample of the slurry was pipetted into a 5 milliliter 0.45 micrometer cellulose acetate Centrex MF centrifugal microfilter (Schleicher & Schuell, available through VWR, Eagan, Minn.). The water was removed by centrifugation at 3000 rcf for 5 min, mixed with 4 mL of 50 mM sodium acetate, pH 4.5, containing 80 mM sodium chloride, and centrifuged again at 3000 rcf for 10 min. Filtrates were discarded. Then a 4.5 mL sample of human IgG (ca. 7 mg/ml) in the same acetate buffer was added to the filter containing the beads. The mixture was mixed by tumbling overnight, and then the supernate was removed from the beads by centrifugation at 3000 rcf for 20 min.

The filtrate was analyzed by UV spectroscopy, comparing the absorbance at 280 nm to that of the starting IgG solution; the difference was used to calculate the IgG capacity of the beads. Assays were run in triplicate and averaged.

Particle Size Measurements

Particle size was measured by light scattering using a Horiba LA-910 instrument (Horiba Laboratory Instruments, Irvine, Calif.).

Pressure/Flow Characterization

A computer controlled test rig consisted of a 1 cm×10 cm glass column, column end fittings, pump, pressure gauge, and appropriate tubing connected to a reservoir containing phosphate buffered saline (PBS). The column was packed with the particles to be measured. Flow through the column was started by turning on the pump, typically starting at 2 ml/min (ca. 150 cm/hr). Flow at this rate was maintained to ascertain that the pressure drop was stable (typically 5 to 15 min), and then the flow rate was increased by 2 or 4 ml/min increments, again monitoring the pressure drop across the column. This procedure was continued until the column failed. Failure was defined as a pressure exceeding 170 psi, at which point the computer automatically shut down the system.

Human IgG Capture by Protein A Affinity

Particles to be tested for Human IgG Capture were loaded with protein A and packed on a cartridge filter (either a Pall Filling Machine Capsule cartridge, 5 micrometer pore size, 300 cm² of filtration layer area or a CUNO Betapure Capsule filter cartridge, 2 micrometer pore size, 900 cm² of filtration layer area) by pumping a bead slurry through the filter, followed by pumping PBS buffer for a buffer exchange. After draining the buffer from the cartridge filter housing, human IgG solution (1.0 mg/mL in 10 mM PBS pH 7.2, 1,500 mL total volume) was loaded into the reservoir, pumped into the filter cartridge housing and returned to the reservoir for recirculation. The flow rate was 400 mL/min with a pressure drop of less than 35 psi (0.24 MPa). The solution was recirculated for 4-30 minutes until the IgG capture rate reached close to zero, which was determined by on-line monitoring of the IgG concentration by UV absorbance at 280 nm wavelength. The solution was drained from the filter housing through an inlet tube and the beads in the filter cartridge were regenerated by washing, elution of captured IgG and buffer exchange. The regenerated beads in the cartridge filter were then used to capture the remaining IgG in the solution. This cycle was repeated 5 times to capture most of the IgG (93-99%) in the solution. Capture performance at each cycle and overall capture rate were recorded.

Table of Abbreviations

| Abbreviation or | |
|---|---|
| Trade | |
| Designation | Description |
| MBA | N,N′-methylenebisacrylamide |
| VDM | 4,4-dimethyl-2-vinyl-1,3-oxazolin-4-one |
| | (vinyldimethylazlactone) |
| AMPS | 2-acrylamido-2-methylpropanesulfonic acid |
| | commercially available as a 50% aqueous |
| | solution of the sodium salt, AMPS 2405 Monomer, |
| | from Lubrizol Corp., Wickliffe, Ohio. |
| TMEDA | N,N,N′,N′-tetramethylethylenediamine. |
| CM-Sephadex | A weak cation exchange resin available from Amersham |
| C50 | Biosciences; Piscataway, NJ |
| PEG 400 | polyethyleneglycol, average molecular weight 400 |
| Buffer A | 1.018 M sodium sulfate in 0.135 M MOPS [3-(N- |
| | morpholino)propanesulfonic acid], pH 7.55 |
| Buffer B | 1.27 M sodium sulfate, 0.4 M Tris |
| | (tris(hydroxymethyl)aminomethane) in 0.1 M MOPS, |
| | pH 7.5 |
| PBS | Buffer solution of sodium phosphate in 140 mM NaCl, |
| | pH 7.2 |
| IgG | Lyophilized human IgG, from EQUITECH-BIO, Inc, |
| | Kerrville, TX. |

### Preparative Example 1

A 35:65 by weight AMPS/MBA copolymer was prepared by reverse-phase suspension polymerization as described in U.S. Pat. No.5,403,902. A polymeric stabilizer (0.28 grams), toluene (132 mL), and heptane (243 mL) were added to a flask equipped with a mechanical stirrer (stirring rate 450 rpm), nitrogen inlet, thermometer, heating mantle with temperature controller, and condenser. The polymeric stabilizer was a 91.8: 8.2 by weight copolymer of isooctyl acrylate and 2-acrylamidoisobutyramide (prepared as described in Rasmussen, et al., Makromol. Chem., Macromol. Symp., 54/55, 535-550 (1992)). The non-aqueous solution in the flask was heated to 35° C. with stirring, and sparged with nitrogen for 15 minutes.

An aqueous solution was prepared that contained MBA (9.10 grams), AMPS (9.80 grams of a 50% by weight aqueous solution), methanol (50 mL), and deionized water (45.1 mL). This second solution was stirred and heated at 30-35° C. to dissolve the MBA. Sodium persulfate (0.5 grams) was added to the second solution with additional stirring to dissolve the persulfate. The aqueous solution was added to the reaction flask containing the non-aqueous solution. The resulting mixture was stirred and nitrogen sparged for 5 minutes. TMEDA (0.5 mL) was added to initiate the polymerization. The reaction temperature quickly rose to 42.5° C., then slowly subsided. The reaction mixture was stirred for a total of 2.5 hours from the time of TMEDA addition, filtered using a sintered glass funnel, washed with acetone (5×250 mL), and dried at room temperature under vacuum to yield 15.7 grams of colorless particles.

### Preparative Examples 2-3

The same reverse phase polymerization procedure described in Preparative Example 1 was followed with reagent levels to give a 65:35 by weight AMPS/MBA copolymer (Preparative Example 2) and a 40:60 by weight AMPS/MBA copolymer (Preparative Example 3).

### Example 1

A 65:35 by weight AMPS/MBA copolymer was prepared by reverse-phase suspension polymerization as described in Preparative Example 2. Equilibrium cation exchange capacity for lysozyme was measured and found to be 160 mg/ml. Microscopic examination revealed spherical particles ranging from about 10-200 micrometers in diameter. An attempt to measure pressure/flow properties resulted in column over pressurizing at the lowest flow rate. A sample of these particles was classified to provide a size range of about 45-110 micrometers. Pressure/flow characterization of this classified sample produced a pressure drop of 20 psi (˜0.14 MPa) at 2 ml/min (150 cm/hr), but failed (>170 psi=1.17 MPa) at 3 ml/min (ca. 230 cm/hr).

A sample of nonclassified beads were evaluated in the following system: Filter Cartridge: Pall Versapor cartridge, 3 micrometer pore size, 1480 cm² of filtration layer area
Beads: AMPS/MBA (65/35); 5 ml hydrated bed volume
Lysozyme loading solution: 2 mg/ml in 10 mM MOPS pH=7.5 1000 ml
Buffer: 10 mM MOPS pH=7.5
System Volume (of housing and tubing): 450 ml
Flow: 1120 ml/min with<5 psi pressure drop
   Procedure:

The system volume was determined by filling, draining, and measuring the volume three times and averaging the results. The flow rate was measured with a stopwatch and graduated cylinder (also the average of three runs) for a specific pump setting. The beads were then packed on the filter by making a slurry of the beads with 50 ml of the buffer.

This slurry was added in two portions to a volume (ca. 1000 ml) of the buffer, then pumped through the filter, allowing the buffer to clarify between added portions. Residual beads were loaded by two rinses of the original container, allowing recirculation of the buffer for 15 additional minutes after the rinses clarified. The pump was turned off, the lines transferred to the lysozyme solution, and the pump started to begin the recirculation. The solution was recirculated for 90 minutes and samples were pulled periodically to measure (UV absorbance) the amount of lysozyme remaining in the loading solution. These results are shown in Table 1.

### Comparative Example 1

A 40:60 by weight AMPS/MBA copolymer was prepared by reverse-phase suspension polymerization as described in Preparative Example 3. The formed beads were classified to provide a size range of about 40-110 micrometers. Equilibrium capacity for lysozyme was measured to be 113 mg/ml. Pressure/flow characterization of this classified sample produced a stable pressure drop of 50 psi (0.34 MPa) at 10 ml/min (760 cm/hr), then slightly increasing pressure drops at higher flow rates, finally failing at>1000 cm/hr. This bead was also evaluated in the system described in Example 1 and the results are shown in Table 1.

TABLE 1

| Time | Example 1 Mass on Bead | Comparative Example 1 |
|---|---|---|
| (minutes) | (mg/mL) | Mass on Bead (mg/mL) |
| 0 | 0 | 0 |
| 5 | 59.48 | 46.79 |
| 10 | 66.06 | 56.29 |
| 15 | 75.79 | 50.45 |
| 20 | 79.95 | 55.00 |
| 25 | 88.68 | 57.93 |
| 30 | 86.60 | 64.11 |
| 40 | 94.41 | 69.64 |
| 50 | 88.46 | 77.06 |
| 60 | 103.95 | 70.69 |
| 70 | 108.07 | 90.34 |
| 80 | 113.18 | 84.83 |
| 90 | 115.79 | 84.95 |
| 100 | NM | 86.06 |

NM = not measured

### Comparative Example 2

A 65:35 by weight AMPS/MBA copolymer was prepared by reverse-phase suspension polymerization as described in Preparative Example 2 from AMPS (36.4 g of 50% aqueous solution), MBA (9.8 g), DI water (31.8 ml), and isopropanol (100 ml). Equilibrium cation exchange capacity for lysozyme was measured and found to be 25 mg/ml and the equilibrium cation exchange capacity for IgG was found to be 7 mg/ml.

### Example 2

A monolithic medium was prepared having the same formulation as the aqueous phase of Comparative Example 2. MBA (0.993 g), a 50 wt % solution of AMPS in water (3.649 g), deionized water (2.88 mL) and isopropanol (10 mL) were mixed and gently heated with stirring in a glass vessel. After the mixture was fully dissolved, it was transferred to a polyethylene pouch (ca. 10 cm×7 cm×0.15 mm wall thickness) and a solution of sodium persulfate (0.0512 g) in water (0.3 mL) was added together with TMEDA (0.05 mL). The pouch was immediately heat-sealed, and then gently shaken on an orbital shaker at room temperature overnight. The pouch was cut open and the polymer mass was transferred to a filter funnel, where it was washed thoroughly with water, then acetone, and dried under vacuum overnight. The dried sample was ground lightly in a mortar and pestle. Particle size measurement indicated a very broad distribution, with particles ranging in size from 1 micrometer to 700 micrometers.

When evaluated in the cartridge system described in Example 1, the ground monolith bound lysozyme very rapidly, achieving a capacity of>46 mg/ml within 15 minutes. The rapid uptake kinetics and increased capacity of this material relative to that of Comparative Example 2 might be explained by improved mass transport and porosity in the monolithic medium.

### Example 3

A 65:35 by weight AMPS/MBA copolymer was prepared as described in Example 1 except that the polymerization time was extended from 2.5 hours to 5 hours. This sample was classified by elutriation into three size ranges—small cut, middle cut, and large cut. The middle cut was discarded and the mean particle sizes of the small and large cuts were determined to be 37.6 micrometers (Small Beads) and 160.0 micrometers (Large Beads). These two samples were then evaluated in the cartridge system described in Example 1. The results of lysozyme capture are listed in Table 2.

TABLE 2

| Time | Small Beads | Large Beads |
|---|---|---|
| (minutes) | (mg/mL) | (mg/mL) |
| 0 | 0 | 0 |
| 2 | 109 | 87 |
| 4 | 131 | 111 |
| 6 | 145 | 118 |
| 8 | 153 | 125 |
| 10 | 158 | 132 |
| 15 | 168 | 139 |
| 20 | 176 | 153 |
| 25 | 178 | 159 |
| 30 | 180 | 168 |
| 40 | 186 | 172 |
| 50 | 188 | 186 |
| 60 | 189 | 192 |
| 70 | NM | 196 |
| 80 | NM | 204 |
| 90 | NM | 210 |

NM = not measured

### Example 4

CM-Sephadex C50 is a useful ion exchange resin for small scale protein purifications. The manufacturer recommends a maximum flow rate of 45 cm/hr, indicating that this resin is too soft for large-scale column use. A sample was hydrated in 10 mM sodium phosphate buffer by mixing overnight at 40° C. 10 ml of settled resin was loaded into the separation system described in Example 1 and evaluated for IgG adsorption by recirculating a solution of rabbit IgG (0.17 mg/ml in 10 mM phosphate, pH 7.2) through the loaded filter capsule at a flow rate of 1134 ml/min. UV analysis of samples taken over time indicated a rapid adsoption of IgG, with 3.9 mg/ml of resin adsorbed in 6 minutes, and equilibrium adsorption of 4.5 mg/ml attained within 25 minutes. Available capacity (saturated capacity) is stated by the manufacturer to be 7 mg/ml. No change in flow rate or increase in pressure was observed during the experiment.

### Example 5

A 95:5 by weight MBA/VDM copolymer bead was prepared according to the general procedure described in Preparative Example 1. The organic phase consisted of heptane (348 ml), stabilizer (0.13 g), and VDM (0.72 g). The aqueous phase consisted of isopropanol (90 ml), water (55 ml), MBA (13.33 g), sodium persulfate (0.55 g), and TMEDA (0.55 ml). This bead (5A) was evaluated for hydration volume in deionized water and for myoglobin coupling capacity as described in P. R. Johnson, et al., J. Chromatogr. A, 1994, 667, 1-9. Results are shown in Table 3. A second MBA/VDM copolymer was prepared using the same ingredients and amounts, except that the volume of isopropanol was increased to 125 ml and the water was increased to 75 ml. This bead (5B) was also evaluated for hydration volume and myglobin coupling capacity. Results are listed in Table 3.

TABLE 3

| Bead | Hydration Volume (ml/g) | Myoglobin Coupling (mg/g) |
|---|---|---|
| 5A | 9.6 | 466 |
| 5B | 12.4 | 533 |

### Examples 6-8

Copolymer beads of 95:5 by weight MBA/VDM were prepared according to the procedure described in Example 5A except that toluene (188 ml) was added to the organic phase, and the total volume of water was increased to 60 ml. For Example 6 the polymeric stabilizer used was a 92.5:7.5 by weight copolymer of isooctyl acrylate and acrylic acid (0.27 g) and the stirring rate was increased to 600 rpm; for Example 7 the polymeric stabilizer used was a 90:10 by weight copolymer of isooctyl acrylate and acrylic acid, and sodium hydroxide (3.7 ml of a 0.1 M solution) was added to the aqueous phase to neutralize the acrylic acid; and for Example 8 the polymeric stabilizer was a 95:5 by weight copolymer of isooctyl acrylate and acrylic acid (1.06 g), sodium hydroxide (0.74 ml of a 1 M solution) was added to the aqueous phase to neutralize the acrylic acid, sodium dodecylsulfate (3 ml of a 10% by weight aqueous solution) was added to the aqueous phase, and the stirring rate was increased to 750 rpm. After drying, the beads were dry classified to obtain the cut that passed through a 32-micrometer sieve.

Protein A was coupled to the beads from Examples 6-8 according to the teachings of U.S. Pat. No. 5,907,016. Protein A coupling procedure: Prior to reaction, all solutions were equilibrated in a water bath at 25° C. A solution was prepared in a round bottomed flask by dissolving 797.2 mg recombinant Protein A (Repligen Corp., Waltham, Mass.) in 40 mL deionized water. To this solution was added 112 ml Buffer A. The mixture was stirred with an overhead stirrer and 11.44 g of dry beads were added. Stirring was continued for 15 minutes, then 304 ml Buffer B was added and stirring continued for 1 hour. The beads were filtered using a sintered glass funnel. The beads were returned to the reaction flask, 560 ml 3.0 M ethanolamine, pH 9.5, was added, and the mixture stirred for 1 hour. The beads were then filtered, washed 3 times with 265 ml phosphate buffered saline (PBS), pH 7.5, 6 times with 265 ml 0.1 M sodium carbonate buffer, pH 10.5, 2 times with 200 ml PBS, 3 times with 160 ml 2 M guanidine in 2% acetic acid, 3 times with 200 ml PBS, 6 times with 265 ml deionized water, and then stored until use in 160 ml 20% ethanol/deionized water.

After additional classification, bead samples containing about 6.5-7.5 mg Protein A coupled per ml of hydrated bead volume were obtained with the sizes indicated in Table 4. The Protein A-loaded beads were tested for Human IgG Capture using the method described above and the results are presented in Table 5 (Example 6), Table 6 (Example 7) and Table 7 (Example 8). The overall capture rates (or capture productivities) were 40 g/L/hr for Example 6; 72 g/L/hr for Example 7, 125 g/L/hr for Example 8. By comparison, use of 60 micrometer diameter Protein A particles in this system leads to a capture rate of about 20 g/L/hr, very similar to the productivity achieved in a standard large scale chromatography column.

TABLE 4

| | Mean Diameter | Coefficient of Variation |
|---|---|---|
| Example | (micrometers) | (%) |
| 6 | 36.9 | 41.7 |
| 7 | 18.1 | 38.5 |
| 8 | 10.3 | 27.9 |

TABLE 5
Example 6

| | Time | Captured IgG | |
|---|---|---|---|
| Cycle | (min) | (mg/mL) | Capture % |
| Cycle-1 | 10 | 23.8 | 28.0% |
| Cycle-2 | 30 | 47.7 | 56.2% |
| Cycle-3 | 60 | 66.9 | 78.8% |
| Cycle-4 | 90 | 77 | 90.6% |
| Cycle-5 | 120 | 79.1 | 93.1% |

TABLE 6
Example 7

| | Time | Captured IgG | |
|---|---|---|---|
| Cycle | (min) | (mg/mL) | Capture % |
| Cycle-1 | 10 | 27.0 | 31.2% |
| Cycle-2 | 22 | 50.6 | 58.6% |
| Cycle-3 | 38 | 69.9 | 81.0% |
| Cycle-4 | 54 | 81.6 | 94.4% |
| Cycle-5 | 72 | 86.0 | 99.5% |

TABLE 7
Example 8

| | Time | Captured IgG | |
|---|---|---|---|
| | (min) | (mg/mL) | Capture % |
| Cycle-1 | 5 | 29.5 | 34.2% |
| Cycle-2 | 11 | 51.6 | 59.9% |
| Cycle-3 | 21 | 71.1 | 82.5% |
| Cycle-4 | 31 | 81.5 | 94.6% |
| Cycle-5 | 41 | 85.4 | 99.1% |

### Example 9

A monolith of identical composition to that of Example 2 was prepared by polymerizing the monomer mixture in a nitrogen-purged, sealed glass vial. The vials were placed in a water bath at 33° C. overnight. The vial was broken; the monolith plug was washed with water and acetone, lightly ground in a mortar and pestle, and then dried under vacuum. A slurry of these crushed particles in deionized water was made, and packed into a Bio-Rad Poly-Prep Column to a 1 ml bed depth. Equilibrium cation exchange capacity for IgG was measured by adapting the lysozyme procedure to IgG and found to be 35 mg/ml.

A slurry of these crushed particles was packed into a 0.35 ml, 3×50 mm Omnifit column having 0.25 micrometer frits, and dynamic binding capacity for human IgG was measured using an AKTA Explorer chromatographic system (GE Healthcare). The IgG loading buffer was 3.5 mg/ml IgG in 50 mM sodium acetate, 80 mM sodium chloride, pH 4.5. The dynamic loading capacity at 10% breakthrough was determined at 300 cm/hr and at 500 cm/hr, and found to be 20.8 and 15.3 mg/ml, respectively.

### Example 10

A monolith of identical composition to that of Example 9 except that 1.5 ml of the isopropanol was replaced with 1.5 ml of PEG 400. The procedure and workup were identical to that of Example 9. Equilibrium cation exchange capacity for IgG was measured as described for Example 9 and found to be 23 mg/ml.

### Example 11

A monolith of identical composition to that of Example 9 except that 1.68 ml of the isopropanol was replaced with 1.68 ml of I -octanol as a porogen. The procedure and workup were identical to that of Example 9. Equilibrium cation exchange capacity for IgG was measured as described for Example 9 and found to be 30 mg/ml.

### Example 12

A monolith of identical composition to that of Example 10 was prepared by polymerizing 1 ml of the monomer mixture in a nitrogen-purged, Bio-Rad Poly-Prep Column at room temperature overnight. Deionized water (10 ml) was added to the top of the monolith plug, however no flow through the column would occur. Slight nitrogen pressure was applied to the top of the column, but still no flow occurred. The bottom of the column, containing the frit, was cut off but still no flow occurred. Finally, the monolith was crushed, washed, and dried as described in Example 9. Equilibrium cation exchange capacity for IgG was measured as described for Example 9 was found to be 31 mg/ml.

### Examples 13-15

Monoliths of identical composition to that of Example 10 were prepared, except that 5% by weight of the AMPS monomer was replaced with an equivalent weight of n-butylacrylate (Example 13), 10% by weight of the AMPS monomer was replaced with an equivalent weight of n-butylacrylate (Example 14), and 15% by weight of the AMPS monomer was replaced with an equivalent weight of n-butylacrylate (Example 15). The procedure and workup were identical to that of Example 9. Equilibrium cation exchange capacities for IgG were measured as described for Example 9 and found to be 24 mg/ml (Example 13), 16 mg/ml (Example 14), and 5 mg/ml (Example 15).

1. A composite filter medium comprising a filter element comprising at least one layer of a porous fibrous filtration layer, and at least one layer of a stationary phase particulate capable of binding with a target molecule, the stationary particulate selected from the group of particles having an average diameter of less than 50 micrometers, soft polymeric particles, and crushed monolithic polymer particles.

2. The composite filter medium of claim 1 wherein said porous fibrous filtration layer is a woven or nonwoven porous material has an average nominal pore size in the range of 0.1 to 50 micrometers

3. The composite filter medium of claim 1 wherein said stationary phase particulates are selected from the group of particulates capable of binding by adsorption, ion exchange, hydrophobic binding, and affinity binding.

4. The composite filter medium of claim 3 wherein said ion exchange particulates are selected from the group consisting of anion exchange resins and cation exchange resins.

5. The composite filter medium of claim 3 wherein said affinity chromatography stationary phase particulates comprise agarose, cellulose, dextran and vinyl polymers comprising ligands with target molecule affinity.

6. The composite filter medium of claim 1 wherein said stationary phase particulates are organic or inorganic particulates having an average particle diameter of less than 50 micrometers.

7. The composite filter medium of claim 6 wherein said stationary phase particulates have an average particle size of less than 30 micrometers.

8. The composite filter medium of claim 6, where the coefficient of variation of the size of said particles is greater than 30%.

9. The composite filter medium of claim 1, wherein said filter element comprises an upstream surface and a downstream surface, said particulate layer disposed on said upstream surface.

10. The composite filter medium of claim 1, wherein said filtration medium of said filter element is a surface filtration medium.

11. The composite filter medium of claim 1, wherein said filtration medium of said filter element is a depth filtration medium.

12. The composite filter medium of claim 1 wherein said crushed monolithic particulates have a size distribution of 0.1 to 1000 micrometers.

13. The composite filter medium of claim 1 wherein said soft particulates will undergo at least a 10% change in the aspect ratio of the particle under an applied pressure of 50 psi (0.34 MPa).

14. The composite filter medium of claim 13 wherein said soft particulates have an average diameter of less than 50 micrometers.

15. The composite filter medium of claim 13 wherein said soft particulates have an average diameter of less than 30 micrometers.

16. A filter cartridge comprising a filter element comprising a composite filtration medium of claim 1.

17. A separation system for large scale separation of a biomacromolecule comprising the filter cartridge of claim 16, a reservoir containing a solution mixture comprising at least one target biomacromolecule as a solute, and a pump and associated tubing for pumping of the solution mixture through the filter cartridge so as to bind said at least one biomacromolecule to the stationary phase particulates so as to form a target molecule:stationary phase particulates product.

18. The separation system of claim 17 wherein the system is capable of purifying at least 100 g of target biomacromolecule in 24 hours.

19. The separation system of claim 17 wherein said filter cartridge is a dead end filter cartridge.

20. The separation system of claim 17 wherein said pump and associated tubing form a closed loop assembly, and the closed loop assembly provides for recirculation pumping of the solution mixture.

21. The separation system according to claim 20 further comprising means for pumping an eluting solution through the closed loop assembly which is capable of reversing the biomacromolecule:stationary phase particulate product binding interaction so as to liberate the target molecule.

22. A method of separating a target molecule from a solution mixture comprising the steps of
a) providing a separation system containing a filter cartridge comprising a composite filter medium of claim 1 capable of binding with a target molecule, a reservoir containing a solution mixture comprising at least one target molecule as a solute, and a pump and associated tubing, and
b) pumping the solution mixture through the filter cartridge at a pressure of at most 50 psi. (0.34 MPa) so as to bind said at least one biomacromolecule to the stationary phase particulates so as to form a target molecule:stationary phase particulates product.

23. The method according to claim 22 wherein the stationary phase particulates are selected from the group of particulates capable of binding by adsorption, ion exchange, hydrophobic binding, and affinity binding.

24. The method according to claim 22 wherein said target molecule is selected from the group consisting of a protein, carbohydrate, lipid, and nucleic acid.

25. The method according to claim 22 wherein the recirculation pumping causes the concentration of the separated target molecule to be increased relative to the concentration of the target molecule in the solution mixture.

26. A method for conducting large scale bioseparations, said method comprising the steps of
a) providing a separation device comprising stationary phase particulates capable of binding a biomacromolecule, the stationary phase particulates being selected from the group of organic or inorganic particles having an average diameter of 50 micrometers or less, soft polymeric particles, and crushed monolithic polymer particles, and a solution mixture comprising at least one biomacromolecule as a solute, the biomacromolecule being produced in a large scale bioreactor having a volume of 100 liters or more, and
b) applying the solution mixture to the separation device so as to bind said at least one biomacromolecule to the stationary phase particulates so as to form a biomacromolecule:stationary phase particulates product, the separation method being accomplished in a period of 24 hours or less.
